(19) United States
(12) Patent Application Publication
(10) Pub. No.: US 2011/0256375 A1
(43) Pub. Date: Oct. 20, 2011

(54) COATING LAYER FOR SOLAR BATTERIES, AND ITS PRODUCTION PROCESS

(75) Inventors: Toru YOSHIDA, Shunan-city (JP); Yasukazu Kishimoto, Tokyo (JP)

(73) Assignee: TOSOH F-TECH, INC., Shunan-city (JP)

(21) Appl. No.: 12/830,635

(22) Filed: Jul. 6, 2010

(30) Foreign Application Priority Data
Apr. 16, 2010 (JP) PCT/JP2010/056825

(51) Int. Cl. C08L 33/06

(52) U.S. Cl. 428/220; 524/502

(57) ABSTRACT

The invention has for its object to coat a single layer form of low-refractive organic thin-film layer on a cover glass of a solar battery to enhance the light-collection efficiency of a solar battery module by a simple method, thereby enhancing the ability of collect sunlight.

The invention provides a coating layer for solar batteries which can be formed directly on a protective layer of a solar battery module and used in direct contact with the air. The fluorine-containing coating layer for solar batteries is characterized by having a fluorine content of 5% by weight or greater. This coating layer or protective layer is formed by polymerizing and curing a composition comprising a methacrylate compound and/or an acrylate compound containing a fluoroalkyl group and/or a fluorine-containing polymer dissolved or dispersed in an organic solvent, a fluorine-free organic compound containing 1 to 5 acryloyl groups or methacryloyl groups, and a photo-polymerization initiator, optionally with the addition of fumed silica to it.

### TECHNICAL FIELD

The present invention relates to a technique of forming, by a simple method, a single low-refractive organic film layer on a protective layer such as a cover glass of photovoltaic power generation equipment called a solar battery, thereby making improvements in the ability to collect sunlight.

### BACKGROUND ART

In recent years, photovoltaic power generation has been in the limelight for the purpose of curtailing CO₂ emissions that is a chief factor of global warming, and addressing fossil fuel depletion problems, and technologies for enhancing power generation efficiency have been under brisk development. Although improvements in the photovoltaic (photoelectric transformation) efficiency of power generation devices themselves are inevitable, yet improvements in the ability of solar batteries to collect sunlight are also an important challenge.

To boost up light-collection efficiency, for instance, methods of improving the material of, and coating on, the protective layer of a solar battery power-generation module are now under study with some expectations. Note here that a glass material is mainly used for the protective layer, and that glass protective layer is generally called a cover glass.

JP(A) 2004-292194 (Patent Publication 2) discloses a production process for producing a glass sheet having a low-reflective film, in which a coating solution for forming a low-reflective film is coated on a cover glass, and then fired to form a low-reflective film. The invention of this publication has for its object to provide a production method for producing a glass sheet having a single low-reflective film of silicon oxide in which the refractive index of the silicon oxide film is controlled by firing conditions thereby keeping visible ray reflectivity low, making improvements in durability such as wear resistance and chemical resistance, and allowing it to have any desired thickness with high hardness maintained. To this end, a coating solution comprising (A) an organosilicon compound, (B) a binder resin that decomposes thermally at 40 to 270° C. and (C) an organic solvent is coated and dried on the surface of a transparent glass substrate, and the resulting glass substrate having a coating film is fired at 400 to 800° C. so that the post-firing coating has a porosity of 15 to 25%.

For this method, however, it is required to completely fire the thin film at the firing step to form a low-reflective film. Still, it is not easy to obtain a protective layer having an improved light-collection capability for a solar battery power generation module, because the thin film crystallizes with the progress of firing and gets densified; a completely fired thin film becomes low in porosity and hence high in refractive index.

In another method studied and tried to enhance light-collection efficiency, a multilayered film comprising a high-refractive-index layer and a low-refractive-index layer is formed on a cover glass. For the purpose of solving a problem with the cover glass serving to protect the surface of a solar battery module: sunlight is reflected off the cover glass, giving rise to a decrease in the quantity of light transmitting through the surface of a solar battery cell and, hence, a decrease in power generation, JP(A) 2008-260654 (Patent Publication 3) discloses a glass having high sunlight transmission capability in which by means for stacking a combined thin layer having high refractive index and low refractive index on one or both surfaces of that cover glass, reflection of light in a wavelength range which is to be subjected to effective photoelectric transformation at a solar battery cell is so reduced that the quantity of light transmission is improved.

However, such a multilayered film as described in JP(A) 2008-260654 has problems in that there is much difficulty in obtaining the desired performance and achieving uniform properties with good reproducibility, because the production process takes much time, and the thickness of each thin film has a grave influence on reflectivity as well.

There is still mounting demand for the development of a coating layer for solar batteries which can not only obtain the necessary performance in a single layer form, but also be produced simply yet at low costs.

For the purpose of providing a novel component for forming a cured product whose refractive index can be chosen, which has a low refractive index, and which can be in close contact with optical parts, JP(A) 2002-332313 (Patent Publication 1) discloses a composition comprising a perfluoroalkyl group-containing prepolymer in which a perfluoroalkyl group-containing (meth)acrylate and a crosslinking, functional group-containing (meth)acrylic acid derivative are copolymerized.

However, when a fluoroalkyl ester of methacrylic acid or acrylic acid serves as a component of an organic material such as polymers, it may give processability and coatability, to say nothing of low refractivity, to the material at low costs, yet it does not reach any practical level because it has low mechanical strength, so it is not suited for applications where it is exposed directly to the air in open space.

### CITATION LIST

### Patent Literature

Patent Publication 1: JP(A) 2002-332313

Patent Publication 2: JP(A) 2004-292194

Patent Publication 3: JP(A) 2008-260654

### SUMMARY OF INVENTION

### Technical Problem

An object of the invention is to provide a coating layer for solar batteries, which can be formed by a simple method, has a low enough refractive index and high mechanical strength even in a single layer form, and can be coated on a cover glass or other protective layer of a solar battery module in particular thereby enhancing light-collection efficiency.

### Solution to Problem

To accomplish the aforesaid object, the present invention is embodied as follows.

(1) A coating layer form solar batteries, comprising a resin containing at least fluorine and an acrylic acid or methacrylic acid derivative, wherein said fluorine is contained in an amount of 5% by mass or greater, said coating layer being formed on a protective layer of a solar battery module in direct contact with the air.

(2) The coating layer for solar batteries according to (1) above, wherein said fluorine is contained in an amount of 20 to 80% by mass.

(3) The coating layer for solar batteries according to (1) or (2) above, which has a film thickness of 30 nm to 300 nm, and has a refractive index of 1.30 to 1.50 with respect to light of 400 nm wavelength.

(4) The coating layer for solar batteries according to any one of (1) to (3) above, which has an angle of contact of 65 degrees to 120 degrees with water.

(5) The coating layer for solar batteries according to any one of (1) to (4) above, which is obtained by forming into a film a composition comprising at least either one of the following components (a) and (b), the following component (c) and an organic solvent:
Component (a): one or two or more of methacrylate compounds and acrylate compounds containing a fluoroalkyl group having 1 to 10 carbon atoms,
Component (b): a fluorine-containing polymer, and
Component (c): one or two or more of acrylic acid derivative and methacrylic acid derivatives containing 1 to 5 acryloyl groups or methacryloyl groups.

(6) A process for producing a coating layer for solar batteries, wherein a composition comprising at least either one of the following components (a) and (b), the following component (c) and an organic solvent is formed into a film that is in turn polymerized and cured to obtain a coating layer for solar batteries:
Component (a): one or two or more of methacrylate compounds and acrylate compounds containing a fluoroalkyl group having 1 to 10 carbon atoms,
Component (b): a fluorine-containing polymer, and
Component (c): one or two or more of acrylic acid derivative and methacrylic acid derivatives containing 1 to 5 acryloyl groups or methacryloyl groups.

(7) The production process according to according to (6) above, wherein said component (b) is contained in an amount of 0.1 to 50 parts by weight, and said component (c) is contained in an amount of 1 to 50 parts by weight.

(8) The production process according to according to (6) above, wherein both said components (a) and (b) are contained, said component (a) being contained in an amount of 1 to 90 parts by weight and said component (b) being contained in an amount of 0.1 to 50 parts by weight, and said component (c) is contained in an amount of 1 to 50 parts by weight.

(9) The production process according to any one of (6) to (8) above, wherein fumed silica is contained as a component (d).

(10) The production process according to (9) above wherein said component (a) is contained in an amount of 1 to 90 parts by weight, and said component (c) is contained in an amount of 1 to 50 parts by weight.

(11) The production process according to any one of (6) to (10) above, wherein a polymerization initiator is further contained.

(12) The production process according to any one of (6) to (11) above, wherein the fluorine-containing polymer that is said component (b) is a copolymer comprising 10 to 50 parts by mole of one or two or more of fluorine-containing polymers having cyclic structures represented by the following formulae (1), (2) and (3) and tetrafluoroethylene, 0 to 50 parts by mole of hexafluoropropylene, 90 to 10 parts by mole of vinylidene fluoride, and 10 to 100 parts by mole of vinyl fluoride:

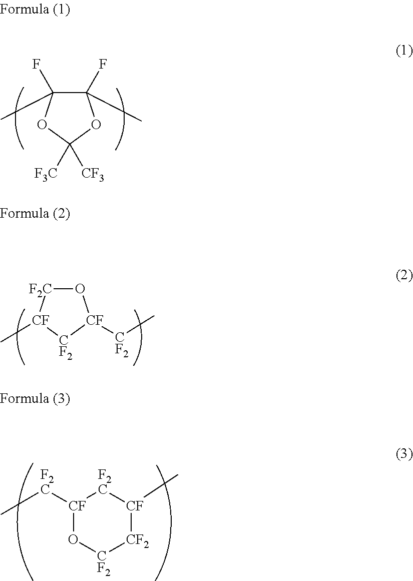

### Advantageous Effects of Invention

According to the invention, it is possible to provide a coating layer for solar batteries, which can be formed by a simple method, has a low enough refractive index and high mechanical strength even in a single layer form, and can be coated on a cover glass or other protective layer of a solar battery module in particular thereby enhancing light-collection efficiency as well as its production process.

### BRIEF DESCRIPTION OF DRAWINGS

FIG. 1 is a SEM image indicative of the section of a protective layer incorporating the inventive coating layer.

### DESCRIPTION OF EMBODIMENTS

The inventive coating layer for solar batteries comprises a resin containing at least fluorine and an acrylic or methacrylic acid derivative, wherein said fluorine is contained in an amount of 5% by mass or greater, said coating layer being formed on a protective layer of a solar battery module in direct contact with the air. Thus, if the coating layer is formed of a resin layer comprising a resin containing at least fluorine and an acrylic acid or methacrylic acid derivative wherein said fluorine is contained in an amount of 5% by mass or greater, it is then possible to form a single resin layer having a low refractive index and high mechanical strength. For this reason, that resin layer is formed as the protective layer of a solar battery so that it can be used in direct contact with the air.

The inventive coating layer contains fluorine in resin that forms it. The incorporating of fluorine enables the refractive index to be kept so low that reflectivity is reduced. The content of fluorine in the coating layer is 5% by mass (by weight) or greater, preferably 20 to 80% by mass (by weight), and more preferably 30 to 76% by mass (by weight).

Varying in relation to the content of fluorine, the refractive index of the coating layer with respect to light of 400 nm wavelength is preferably 1.30 to 1.50, and more preferably 1.34 to 1.49. The refractive index correlates with the content of fluorine. For instance, polytetrafluoroethylene (PTFE) has a refractive index of 1.35 at a fluorine content of 75.98% by mass (by weight) while poly(2,2,2-trifluoroethyl methacrylate) has a refractive index of 1.47 at a fluorine content of 33.9% by mass (by weight). Note here that these resins have much difficulty in being used by themselves for a coating layer in view of their nature. In the invention, the coating layer can be adjusted to the aforesaid fluorine content by adjusting the content of the fluorine-containing resin, the fluorine content of the fluorine-containing resin, etc.

By way of example but not by way of limitation, the coating layer has a film thickness of preferably 30 nm to 300 nm, and more preferably 50 nm to 200 nm, when it is formed as a single protective layer for solar batteries. Too small thicknesses give rise to decreased mechanical strength and a lowering of antireflection effect, whereas too large thicknesses render uniform film formation difficult, and make it difficult to obtain the expected properties.

Another feature of the invention is that the angle of contact is large. Specifically, the angle of contact with water is preferably 65 degrees to 120 degrees, and more preferably 70 degrees to 114 degrees. The coating layer having such an angle of contact is resistant to pollution, and even when it is used in direct contact with the air, its initial performance can be maintained over an extended period of time, and cleaning gets easy as well. For instance, the angle of contact θ may be found from the following equation:

θ=2 tan⁻¹(h/r)

where h and r are the height and radius of a waterdrop, respectively (the ATAN 1/2θ method). It may also be easily determined by PC analysis of a waterdrop image.

The provision of the inventive coating layer makes sure improvements in light ray transmittance. More specifically, it makes a 0.1% to 4% improvement in transmittance with respect to vertical light of light rays incident on the protective layer in the wavelength range of 350 nm to 1,100 nm as compared with the protective layer, i.e., the glass itself, and a 1 to 3% improvement in transmittance with respect to vertical light of light rays in the wavelength range of 380 nm to 750 nm.

The inventive coating layer may be obtained by polymerizing and curing the resin containing at least fluorine and the acrylic acid or methacrylic acid derivative, and the aforesaid resin material would be included in the ensuing coating layer, too. More specifically, the inventive coating layer may be produced by forming into a film a composition comprising at least either one of the following components (a) and (b), the following component (c) and an organic solvent, and polymerizing and curing that film.
Component (a): one or two or more of methacrylate compounds and acrylate compounds containing a fluoroalkyl group having 1 to 10 carbon atoms,
Component (b): a fluorine-containing polymer, and
Component (c): one or two or more of acrylic acid derivativea and methacrylic acid derivatives containing 1 to 5 acryloyl groups or methacryloyl groups. The aforesaid composition may further contain fumed silica as a component (d).

In this case, a polymerization initiator is added to the aforesaid composition that is in turn polymerized and cured with the application of the energy necessary for polymerization such as light, radiations, and heat. This enables a low-refractive-index coating layer to be very easily obtained.

In the invention, component (a): methacrylate compounds and acrylate compounds containing a fluoroalkyl group, and component (b): fluorine-containing compounds such as fluorine-containing polymers take a main role of decreasing the refractive index of the ensuing thin-film composition. On the other hand, component (c): acrylic or methacrylic acid derivatives having 1 to 5 acryloyl groups or methacryloyl groups, and component (d): a fluorine-free compound such as fumed silica make improvements in the hardness and scratch resistance of the ensuing thin-film composition and the adhesion of the ensuing thin-film composition to an application substrate. Thus, with compositions comprising combinations of them, it is possible to obtain an improved coating layer having the combined properties of the former and the latter together.

There is no particular limitation on how to combine the respective components if the composition contains either one of the components (a) and (b), the component (c) and the organic solvent, optionally with the component (d). However, combinations of the components (b) and (c), and all the components (a), (b) and (c) are preferred, and a combination of the components (a) and (c) with the component (d) is preferred as well.

The respective components in the composition should preferably be contained in the following quantitative ranges.

### Component (a)

The methacrylate compound and/or the acrylate compound, each containing a fluoroalkyl group having 1 to 10 carbon atoms, should be contained in an amount of preferably 1 to 90 parts by mass (by weight), more preferably 50 to 90 parts by mass (by weight), and even more preferably 70 to 90 parts by mass (by weight).

### Component (b)

The fluorine-containing polymer should be contained in an amount of preferably 0.1 to 50 parts by mass (by weight), more preferably 0.5 to 50 parts by mass (by weight), and even more preferably 1 to 50 parts by mass (by weight).

### Component (c)

The acrylic acid derivative and/or the methacrylic acid derivative, each containing 1 to 5 acryloyl groups or methacryloyl groups, should be contained in an amount of preferably 1 to 50 parts by mass (by weight), more preferably 1 to 30 parts by mass (by weight), and even more preferably 1 to 25 parts by mass (by weight).

### Component (d)

Fumed silica should be contained in an amount of preferably 0.1 to 10 parts by mass (by weight), more preferably 0.01 to 8 parts by mass (by weight), and even more preferably 0.01 to 5 parts by mass (by weight).

### Component (a)

By way of example but not by way of limitation, the methacrylate compounds and/or acrylate compounds containing a fluoroalkyl group having 1 to 10, preferably 2 to 10, carbon atoms include CF₃(CF₂)₈CH₂O₂CCH═CH₂, CF₃(CF₂)₈CH₂O₂CC(CH₃)═CH₂, HCF₂(CF₂)₇(CH₂)₂O₂CCH═CH₂, HCF₂(CF₂)₇(CH₂)₂O₂CC(CH₃)═CH₂, CF₃(CF₂)₇CH₂O₂CCH═CH₂, CF₃(CF₂)₇CH₂O₂CC(CH₃)═CH₂, CF₃(CF₂)₆CH₂O₂CCH═CH₂, CF₃(CF₂)₆CH₂O₂CC(CH₃)═CH₂, CF₃(CF₂)₅CH₂O₂CCH═CH₂, CF₃ (CF₂)₅CH₂O₂CC(CH₃)═CH₂, CF₃(CF₂)₄CH₂O₂CCH═CH₂, CF₃(CF₂)₄CH₂O₂CC(CH₃)═CH₂, CF₃(CF₂)₃CH₂O₂CCH═CH₂, CF₃(CF₂)₃CH₂O₂CC(CH₃)═CH₂, CF₃(CF₂)₂CH₂O₂CCH═CH₂, CF₃(CF₂)₂CH₂O₂CC(CH₃)═CH₂, (CF₃)₃CCH₂O₂CCH═CH₂, (CF₃)₃CCH₂O₂CC(CH₃)═CH₂, (CF₃)₂CFCH₂O₂CCH═CH₂, (CF₃)₂CFCH₂O₂CC(CH₃)═CH₂, CF₃CF₂CH(CF₃)O₂CCH═CH₂, CF₃CF₂CH(CF₃)O₂CC(CH₃)═CH₂, CF₃CF₂CH₂O₂CCH═CH₂, CF₃CF₂CH₂O₂CC(CH₃)═CH₂, CF₃CF₃CHO₂CCH═CH₂, CF₃CF₃CHO₂CC(CH₃)═CH₂, H₂CFCH₂O₂CCH═CH₂, H₂CFCH₂O₂CC(CH₃)═CH₂, HCF₂CH₂O₂CCH═CH₂, HCF₂CH₂O₂CC(CH₃)═CH₂, CF₃CH₂O₂CCH═CH₂, and CF₃CH₂O₂CC(CH₃)═CH₂, which may be used alone or in admixture of two or more. Among others, 2,2,2-trifluoroethyl methacrylate: CF₃CH₂O₂CCH═CH₂, and 2,2,2-trifluoroethyl acrylate: CF₃CH₂O₂CC (CH₃)═CH₂ is particularly preferred.

### Component (c)

By way of example but not by way of limitation, the acrylic acid derivative and/or methacrylic acid derivative having 1 to 5 acryloyl groups or methacryloyl groups should preferably be free of fluorine. By combination with the fluorine-free acryloyl(methacryloyl) compound, there can be mechanical properties improved.

By way of example but not by way of limitation, such acrylic acid derivatives and/or methacrylic acid derivatives include CH₂O₂CC(CH₃)═CH₂; CH₂O₂CCH═CH₂; commercial products made and sold by Shin-Nakamura Chemical Co., Ltd., and Nippon Kayaku Co., Ltd. such as CH₂═C(CH₃)O₂C(CH₂O)COC(CH₃)═CH₂, CH₂═C(CH₃)O₂C(CH₂O)₂COC(CH₃)═CH₂, CH₂═C (CH₃)O₂C(CH₂O)₃COC(CH₃)═CH₂, CH₂═O(CH₃)O₂C(CH₂O)₄COC(CH₃)═CH₂, CH₂═CHO₂C(CH₂O)₄COCH═CH₂, CH₂═CHO₂C(CH₂O)₆COCH═CH₂, CH₂═CHO₂C(CH₂O)₉COCH═CH₂, CH₂═CHO₂C(CH₂O)₁₀COCH═CH₂, CH₂═C(CH₃)O₂C(CH₂O)₉COC(CH₃)═CH₂, CH₂═C(CH₃)O₂C(CH₂O)₁₄COC(CH₃)═CH₂, CH₂═C(CH₃)O₂C(CH₂O)₂₃COC(CH₃)=CH₂, CH₂═C(CH₃)O₂CCH₂C(CH₃)₂CH₂CO₂C(CH₃)═CH₂, CH₂═CHO₂CCH₂C(CH₃)₂CH₂CO₂CH═CH₂CH₂═C(CH₃)O₂CCH₂CH(OH)CH₂CO₂C (CH₃)═CH₂, CH₂═C(CH₃)O₂C(CH₂)₉CO₂C(CH₃)═CH₂, CH₂═C(CH₃)O₂C(CH₂O)ₘ(C₆H₄C(CH₃)₂C₆H₄)(CH₂O)ₙCOC(CH₃)═CH₂ (m+n=2 to 30), CH₂═CHO₂C(CH₂O)ₘ(C₆H₄C(CH₃)₂C₆H₄)(CH₂O)ₙCOCCH═CH₂ (m+n=2 to 30), tricyclodecanedimethanol dimethacrylate, tricyclodecanedimethanol diacrylate, CH₂═C(CH₃)O₂C(CH₂C(C₂H₅)(CH₂O₂CC(CH₃)═CH₂)CH₂)O₂CC(CH₃)═CH₂, CH₂═CHO₂C(CH₂C(C₂H₅)(CH₂O₂CCH═CH₂)CH₂)O₂CCH═CH₂, CH₂═CHO₂C(CH₂C(CH₂O₂CCH═CH₂)O₂CCH═CH₂, and CH₂═CHO₂C(CH₂C(CH₂O₂CCH═CH₂)₂CH₂)OCH₂C(CH₃)₂(CH₂O₂CCH═CH₂)₂; commercial products made and sold by Tokushiki Co., Ltd., Shin-Nakamura Chemical Co., Ltd. or Nippon Kayaku Co., Ltd. such as urethane dimethacrylate compounds or urethane diacrylate compounds having an urethane skeleton; and urethane dimethacrylate compounds, urethane diacrylate compounds, and urethane methacrylate acrylates derived from Karenz Series that are isocyanate monomers sold by Showa Denko Co., Ltd. These may be used alone or in admixture of two or more.

### Component (d)

The inventive composition may further contain fumed silica as necessary. By incorporation of fumed silica, the refractive index and other performances of the obtained film can be improved. This is particularly effective for the aforesaid combination of the components (a) and (c). The fumed silica that may be used herein has a primary particle average diameter of preferably 1 to 100 nm, and more preferably 3 to 50 nm, and a specific surface area (Sm=S/ρV where S is the surface area, ρ is the density, and V is the volume) of preferably 10 to 1,000 m²/g, and more preferably 40 to 400 m²/g. Note here that the specific surface area is usually measured by the gas adsorption method (BET), the permeability method or the like. For the fumed silica products sold by Evonik Ltd. for instance, there may be the mention of R202, R805, R812, R812S, RX200, RY200, R972, R972CF, 90G, 200V, 200CF, 200FAD, and 300CF, and that fumed silica may be used with finely divided titania, zirconia, alumina, silica-alumina, etc. that may be used alone or in admixture of two or more. The amount of such materials mixed with fumed silica may be selected from a range without detrimental to the function of the aforesaid main components.

### Component (b)

While there is no particular limitation placed on the fluorine-containing polymer used in the composition according to the invention, yet it must be soluble or dispersible in the organic solvent. In particular, preference is given to the fluorine-containing polymers having cyclic structures represented by the following formulae (1), (2), (3) and/or copolymers of monomers: tetrafluoroethylene, hexafluoropropylene, vinylidene fluoride, and vinyl fluoride.

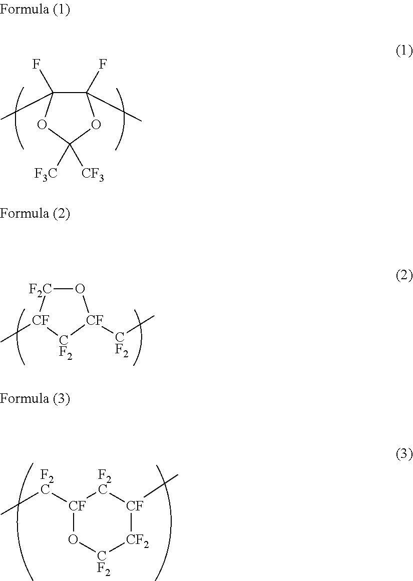

The respective monomers should preferably have the following content ranges.

10 to 50 parts by mole, preferably 10 to 45 parts by mole, and more preferably 10 to 40 parts by mole of Fluorine-containing polymer having cyclic structures represented by formulae (1) to (3) and/or tetrafluoroethylene, 0 to 50 parts by mole, preferably 0 to 45 parts by mole, and more preferably 0 to 40 parts by mole of hexafluoro-propylene, 90 to 10 parts by mole, preferably 85 to 10 parts by mole, and more preferably 80 to 10 parts by mole of vinylidene fluoride, and 10 to 100 parts by mole, preferably 15 to 100 parts by mole, and more preferably 20 to 100 parts by mole of vinyl fluoride.

The aforesaid fluorine-containing polymers are commercially available and, for instance, there may be the mention of Teflon (registered trademark) AF Series (Du Pont), Fluon Series (Asahi Glass Co., Ltd.), Hiflon Series (Solvay S.A.), Cytop (Asahi Glass Co., Ltd.), THV Series (Sumitomo 3M Co., Ltd.), Neoflon Series (Daikin Industries, Ltd.), Kynar Series (Alkema), Tedorar Series (Du Pont), and Dyneon Series (Dyneon Co., Ltd.). These may be used alone or in admixture of two or more.

For the fluorine-containing polymer that may be used herein, use may further be made of polymers comprising the methacrylate compounds and/or acrylate compounds, each containing a fluoroalkyl group having 1 to 10 carbon atoms, as exemplified as the aforesaid component (a). Particular preference is given to a polymer obtained by thermal polymerization of one, or a mixture of two or more, of the compounds exemplified as the component (a), and for the preferable component (a), see above. These polymers should have a number-average molecular weight of preferably 5,000 to 3,000,000, more preferably 5,000 to 2,000,000, and even more preferably 5,000 to 1,500,000, as calculated on a polystyrene basis (that is, when polystyrene is used as the polymer), and other polymers too should have such a number-average molecular weight in a molecular ratio to polystyrene.

If the organic solvent used here allows the aforesaid fluorine-containing polymer to be soluble or dispersible in it, there is no particular limitation on it. Specifically, there are fluoroalcohol base solvents such as CF₃CH₂OH, F(CF₂)₂CH₂OH, (CF₃)₂CHOH, F(CF₂)₃CH₂OH, F(CF₂)₄C₂H₅OH, H(CF₂)₂CH₂OH, H(CF₂)₃CH₂OH, and H(CF₂)₄CH₂OH; fluorine-containing aromatic solvents such as perfluoro-benzene, and m-xylenehexafluoride; and fluorocarbon base solvents such as CF₄(HFC-14), CHClF₂(HCFC-22), CHF₃(HFC-23), CH₂CF₂(HFC-32), CF₃CF₃(PFC-116), CF₂ClCFCl₂(CFC-113), C₃HClF₅(HCFC-225), CH₂FCF₃(HFC-134a), CH₃CF₃(HFC-143a), CH₃CHF₂(HFC-152a), CH₃CCl₂F(HCFC-141b), CH₃CClF₂(HCFC-142b), and C₄F₈(PFC-C318).

There are also hydrocarbon base solvents such as xylene, toluene, Solvesso 100, Solvesso 150, and hexane; ester base solvents such as methyl acetate, ethyl acetate, butyl acetate, acetic acid ethylene glycol monomethyl ether, acetic acid ethylene glycol monoethyl ether, acetic acid ethylene glycol monobutyl ether, acetic acid diethylene glycol monomethyl ether, acetic acid diethylene glycol monoethyl ether, acetic acid diethylene glycol monobutyl ether, acetic acid ethylene glycol, and acetic acid diethylene glycol; ether base solvents such as dimethyl ether, diethyl ether, dibutyl ether, ethylene glycol monomethyl ether, ethylene glycol monoethyl ether, ethylene glycol monobutyl ether, ethylene glycol dimethyl ether, ethylene glycol diethyl ether, ethylene glycol dibutyl ether, diethylene glycol monomethyl ether, diethylene glycol monoethyl ether, diethylene glycol monobutyl ether, diethylene glycol dimethyl ether, diethylene glycol diethyl ether, diethylene glycol dibutyl ether, and tetrahydrofuran; ketone base solvents such as methyl ethyl ketone, methyl isobutyl ketone, and acetone; amide base solvents such as N,N-dimethylacetoamide, N-methylacetoamide, acetoamide, N,N-dimethylformamide, N,N-diethylformamide, and N-methylformamide; sulfonic acid ester base solvents such as dimethylsulfoxide; methanol; ethanol; isopropanol; butanol; ethylene glycol; diethylene glycol; and polyethylene glycol (having a polymerization degree of 3 to 100). These solvents may be used alone or in admixture of two or more.

It is here noted that among the aforesaid solvents, preference is given to the fluorine base solvents, ketone base solvents and ester base solvents in consideration of solubility, coated films' appearance, and stability on storage. Particular preference is given to the sole or combined use of methyl ethyl ketone, methyl isobutyl ketone, cyclohexanone, Cellosolve acetate, butyl acetate, ethyl acetate, perfluorobenzene, m-xylenehexafluoride, HCFC-225, CFC-113, HFC-134a, HFC-143a, and HFC-142b.

No particular limitation is imposed on the polymerization initiator to be added to the inventive composition; selection may be made from polymerization initiators suitable for applications, the desired properties of films, and production processes. However, photo-polymerization initiators are most recommendable. Use of photo-polymerization initiators relying upon UV curing would result in particularly excellent performance. By way of example but not by way of limitation, the photo-polymerization initiators used here include products made by Novartis AG such as IRGACURE 651, IRGACURE 184, DAROCUR 1173, IRGACURE 2959, IRGACURE 127, IIRGACURE 907, IIRGACURE 369, IIRGACURE 379, DAROCUR TPO, IRGACURE 819, IRGACURE 784, IRGACURE OXE1, IRGACURE OXE2, and IRGACURE 754; and Lcuirin TPO, and Lucirin TPO-L made by BASF. These initiators may be used alone or in admixture of two or more. By way of example but not by way of limitation, the photo-polymerization initiator should be contained in an amount of preferably 0.1 to 20 parts by mass (by weight), more preferably 0.1 to 15 parts by mass (by weight), and even more preferably 1 to 10 parts by mass (by weight). Other polymerization initiators, when used, may also be used in the aforesaid quantitative range.

For acceleration of photo-curing, photosensitizers, for instance, ketone compounds such as benzophenone, dyes such as rose bengal, and conjugative compounds such as fluorene, pyrene or fullerene may be used in a quantity 0.05 to 3 times, preferably 0.05 to 2 times, and more preferably 0.05 to 1.5 times by mass or by weight as much as the photo-initiator.

For photo-curing according to the invention, thermal initiators capable of generating radicals by heating may be used in a quantity 0.05 to 3 times, preferably 0.05 to 2 times, and more preferably 0.05 to 1.5 times by mass or by weight as much as the photo-initiator, or the photo-initiator may be used with the photosensitizer. The thermal initiators used preferably include compounds such as AIBN (azobisisobutyronitrile), ketone peroxide, peroxyketal, hydroperoxide, diallylkyl peroxide, diacyl peroxide, peroxyester, and peroxycabonate or their derivatives. There may also be commercial products used, for instance, products made by NOF Corporation such as Perloyl O, Perloyl L, Perloyl S, Perocta O, Perloyl SA, Perhexa 250, Perhexyl O, Nyper PMB, Perbutyl O, Nyper BMT, Nyper BW, Perbutyl IB, Perhexa MC, Perhexa TMH, Perhexa HC, Perhexa C, Pertetra A, Perhexyl I, Perbutyl MA, Perbutyl 355, Perbutyl L, Perhexa 25MT, Perbutyl I, Perbutyl E, Perhexyl Z, Perhexa V, Perbutyl P, Percumyl D, Perhexyl D, Perhexa 25B, Perbutyl D, Permenta H, and Perhexin 25B.

To obtain the inventive coating layer from the inventive composition, for instance, light is applied to a mixture comprising 1 to 90 parts by mass (by weight) of the methacrylate compound and/or acrylate compound, each containing a fluoroalkyl group having 1 to 10 carbon atoms, 1 to 50 parts by mass (by weight) of the fluorine-free acrylic acid derivative or methacrylic acid derivative having 1 to 5 acryloyl groups or methacryloyl groups, 0.1 to 50 parts by mass (by weight) of the fluorine-containing polymer dissolved or dispersed in the organic solvent and 0.1 to 20 parts by mass (by weight) of the photo-polymerization initiator, thereby obtaining a film-form, low-refractive-index coating layer.

Alternatively, light is applied to a mixture comprising 1 to 50% by weight of the fluorine-free acrylic acid derivative or methacrylic acid derivative having 1 to 5 acryloyl groups or methacryloyl groups, 0.1 to 50% by weight of the fluorine-containing polymer dissolved or dispersed in the organic solvent and 0.1 to 10% by weight of the photo-polymerization initiator, thereby obtaining a film-form, low-refractive-index composition.

Yet alternatively, light is applied to a mixture comprising 1 to 90 parts by mass (by weight) of the methacrylate compound and/or acrylate compound, each containing a fluoroalkyl group having 1 to 10 carbon atoms, 1 to 50 parts by mass (by weight) of the fluorine-free acrylic acid derivative or methacrylic acid derivative having 1 to 5 acryloyl groups or methacryloyl groups, 0.1 to 10 parts by mass (by weight) of fumed silica and 0.1 to 10 parts by mass (by weight) of the photo-polymerization initiator, thereby obtaining a film-form, low-refractive-index composition.

For photo-curing according to the invention, for instance, use may be made of light from high-pressure mercury lamps, constant-pressure mercury lamps, thallium lamps, indium lamps, metal halide lamps, xenon lamps, ultraviolet LED, blue LED, white LED, excimer lamps made by Hanson Toshiba Lighting Cooperation, and H bulbs, H Plus blubs, D bulbs, V bulbs, Q bulbs and M bulbs, all made by Fusion Co., Ltd. Sunlight may be used too.

When the photo-curing reaction hardly proceeds, it is preferred that light irradiation is implemented in the absence of oxygen. In the presence of oxygen, a film surface remains sticky for a while due to oxygen inhibition; the quantity of the initiator used must be increased. It is here noted that in the absence of oxygen, curing may be implemented in an atmosphere of nitrogen gas, carbon dioxide gas, helium gas or the like.

There is no particular limitation imposed on how to form the composition into a film; for instance, the film may be formed by means of coating, printing or dipping. The thickness of the ensuing film may be regulated depending on the amount and type of the solvent used and such additives as viscosity increasers and fine particle additives at the film-formation step such as a curing method.

Although not restrictive, the protective layer, on which the inventive coating layer is to be formed, may be formed of not only a glass material such as synthesized quartz glass, quartz glass, borosilicate glass, and soda lime glass, but also a transparent resin material such as polymetharcrylate, polycarbonate, polyethylene terephthaloate, polyimide, methyl methacrylate-styrene copolymers, polyfumaric acid ester, amorphous polyallylate, methyl methacrylate-butadiene-styrene copolymers, styrene-butadiene copolymers, polyethersulfone, polyether ether ketone, triacetyl cellulose, and polycycloolefine. These materials are preferably used with the protective layer of the solar battery module.

By way of example but not by way of limitation, the invention is now explained more specifically with reference to the following examples.

### EXAMPLES

In each of the following examples, the thickness and refractive index of the obtained coating layer were measured by PG-20 made by Teclock Co., Ltd. and M-150 made by JASCO, respectively. The pensile hardness was measured by KT-VF2391 made by Cotec Co., Ltd. The actinometer used to measure the quantity of light for photo-curing was UV POWER PUCK made by EIT Co., Ltd. Photo-curing was determined by tack-free testing (touch testing). That is, the curing time is defined as a period of time by the time the surface tackiness of the coating layer obtained by light irradiation is removed off. Photo-curing was implemented on a colorless sheet glass (50 mm×50 mm×1.0 mm) made by Shinwa Industry Co., Ltd. The light-collection efficiency of the cured coating layer was determined using UV-1700 made by Shimadzu Co., Ltd. in which a colorless sheet glass with a coating layer formed on it was fixed on a sample light path side and an uncoated colorless sheet glass was fixed on a reference light path side to measure transmitted light in a wavelength range of 1,100 nm to 280 nm for comparison purposes. The angle of contact was measured by DM-301 made by Kyowa Interface Science Co., Ltd., and spin coating was implemented using ACT-300AH made by Active Co., Ltd.

### Example 1

Nine (9.0) grams of 2,2,2-trifluoroethyl meth-acrylate made by Tosoh E-Tech Inc. and 1.0 gram of A-DCP (tricyclodecanedimethanol diacrylate) made by Shin-Nakamura Chemical Co., Ltd. were mixed with 200 mg of IRGACURE 184 made by Novartis AG, and the mixture was stirred until it was visually found to become uniform. A part of the obtained solution was coated on one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 8 μm, a pencil hardness of 5H and a refractive index of 1.44. The light-collection efficiency increased 1.5% in the wavelength range of 1,100 nm to 450 nm, and the angle of contact was 90 degrees as measured by adding pure water (2 μL) dropwise onto the coating layer by means of a micro-syringe.

### Example 2

Nine (9.0) grams of 2,2,2-trifluoroethyl meth-acrylate made by Tosoh E-Tech Inc. and 1.0 gram of A-DCP (tricyclodecanedimethanol diacrylate) made by Shin-Nakamura Chemical Co., Ltd. were mixed with 200 mg of IRGACURE 184 made by Novartis AG and 70 mg of azobis-butyronitrile made by Wako Pure Chemical Industries, and the mixture was stirred until it was visually found to become uniform. A part of the obtained solution was coated on one surface of a glass sheet, and the composition on that glass sheet was irradiated with light from an H bulb made by Fusion Co., Ltd. for about 1 second (320 nm to 390 nm, 500 mJ/cm²), whereupon a tackiness-free transparent coating layer was obtained.

The obtained coating layer was found to have a thickness of 8 μm, a pencil hardness of 5H and a refractive index of 1.44. The light-collection efficiency increased 1.5% in the wavelength range of 1,100 nm to 450 nm.

### Example 3

Nine (9.0) grams of 2,2,2-trifluoroethyl acrylate made by Tosoh E-Tech Inc. and 1.0 gram of A-DCP (tricyclodecanedimethanol diacrylate) made by Shin-Nakamura Chemical Co., Ltd. were mixed with 100 mg of IRGACURE 184 and IRGCURE 754, each made by Novartis AG, and 70 mg of azobisbutyronitrile made by Wako Pure Chemical Industries, and the mixture was stirred until it was visually found to become uniform. A part of the obtained solution was coated on one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 8 μm, a pencil hardness of 5H and a refractive index of 1.44. The light-collection efficiency increased 1.5% in the wavelength range of 1,100 nm to 450 nm.

### Example 4

Nine (9.0) grams of 2,2,2-trifluoroethyl meth-acrylate made by Tosoh E-Tech Inc. and 1.0 gram of A-DCP (tricyclodecanedimethanol diacrylate) made by Shin-Nakamura Chemical Co., Ltd. were mixed with 200 mg of IRGACURE 184 made by Novartis AG and 5 mg of R202 made by Evonik Ltd. (fumed silica treated with dimethyl silicon oil), and the mixture was stirred until it was visually found to become uniform. A part of the obtained solution was coated on one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 10 μm, a pencil hardness of 5H and a refractive index of 1.44. The light-collection efficiency increased 1.5% in the wavelength range of 1,100 nm to 450 nm.

### Example 5

Nine (9.0) grams of 2,2,2-trifluoroethyl acrylate made by Osaka Organic Chemical Industries and 1.0 gram of KAYARAD-R684 (tricyclodecanedimethanol diacrylate) made by Nippon Kayaku Co., Ltd. were mixed with 200 mg of IRGACURE 184 made by Novartis AG, and the mixture was stirred until it was visually found to become uniform. A part of the obtained solution was coated on one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 9 μm, a pencil hardness of 5H and a refractive index of 1.43. The light-collection efficiency increased 1.6% in the wavelength range of 1,100 nm to 450 nm.

### Example 6

Nine (9.0) grams of 2,2,2-trifluoroethyl meth-acrylate made by Tosoh E-Tech Inc. and 1.0 gram of NK-NOD (1,9-nonanediol dimethacrylate) made by Shin-Nakamura Chemical Co., Ltd. were mixed with 200 mg of IRGACURE 184 made by Novartis AG and 5 mg of R202 made by Evonik Ltd. (fumed silica treated with dimethyl silicon oil), and the mixture was stirred until it was visually found to become uniform. A part of the obtained solution was coated on one surface of a glass sheet, and the composition on that glass sheet was irradiated with light from an H bulb made by Fusion Co., Ltd. for about 1 second (320 nm to 390 nm, 500 mJ/cm²), whereupon a tackiness-free transparent coating layer was obtained.

The obtained coating layer was found to have a thickness of 10 μm, a pencil hardness of H and a refractive index of 1.44. The light-collection efficiency increased 1.5% in the wavelength range of 1,100 nm to 450 nm.

### Example 7

Nine (9.0) grams of poly-2,2,2-trifluoroethyl meth-acrylate obtained from 2,2,2-trifluoroethyl methacrylate made by Tosoh F-Tech Inc. by the synthesis process described in Polymer Journal, Vol. 10, 1994, pp. 1118-1123 and 1.0 gram of A-DCP (tricyclodecanedimethanol diacrylate) made by Shin-Nakamura Chemical Co., Ltd. were mixed with 200 mg of IRGACURE 184 made by Novartis AG, 5 mg of R202 made by Evonik Ltd. (fumed silica treated with dimethyl silicon oil) and 500 mL of ethyl acetate, and the mixture was stirred until it was visually found to become uniform. A part (54.3 mg) of the obtained solution was passed by a pipette over one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 10 μm, a pencil hardness of 3H and a refractive index of 1.42. The light-collection efficiency increased 1.7% in the wavelength range of 1,100 nm to 450 nm.

### Example 8

Nine (9.0) grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123 and 1.0 gram of A-TMM-3L (pentaerythritol triacrylate) made by Shin-Nakamura Chemical Co., Ltd. were mixed with 200 mg of IRGACURE 184 made by Novartis AG, 5 mg of R202 made by Evonik Ltd. (fumed silica treated with dimethyl silicon oil) and 450 mL of methyl ethyl ketone, and the mixture was stirred until it was visually found to become uniform. A part (54.3 mg) of the obtained solution was passed by a pipette over one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 10 μm, a pencil hardness of 3H and a refractive index of 1.42. The light-collection efficiency increased 1.7% in the wavelength range of 1,100 nm to 450 nm, and the angle of contact was 88 degrees as measured by adding pure water (2 μL) dropwise onto the coating layer by means of a micro-syringe.

### Example 9

Four point five (4.5) grams of 2,2,2-trifluoroethyl acrylate made by Tosoh F-Tech Inc., 4.5 grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123, and 1.0 gram of A-TMM-3L (pentaerythritol triacrylate) made by Shin-Nakamura Chemical Co., Ltd. were mixed with 200 mg of IRGACURE 184 made by Novartis AG and 450 mL of butyl acetate, and the mixture was stirred until it was visually found to become uniform. A part (54.3 mg) of the obtained solution was passed by a pipette over one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 10 μm, a pencil hardness of 3H and a refractive index of 1.42. The light-collection efficiency increased 1.6% in the wavelength range of 1,100 nm to 450 nm.

### Example 10

Four point five (4.5) grams of 2,2,2-trifluoroethyl acrylate made by Tosoh F-Tech Inc., 4.5 grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123, and 1.0 gram of A-TMM-3L (pentaerythritol triacrylate) made by Shin-Nakamura Chemical Co., Ltd. were mixed with 200 mg of IRGACURE 184 made by Novartis AG and 5 mg of R202 made by Evonik Ltd. (fumed silica treated with dimethyl silicon oil), and the mixture was stirred until it was visually found to become uniform. A part (54.3 mg) of the obtained solution was passed by a pipette over one surface of a glass sheet, and the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

The obtained coating layer was found to have a thickness of 11 μm, a pencil hardness of 3H and a refractive index of 1.42. The light-collection efficiency increased 1.6% in the wavelength range of 1,100 nm to 450 nm.

### Example 11

Four point five (4.5) grams of poly-2,2,2-trifluoroethyl methacrylate obtained from 2,2,2-trifluoroethyl methacrylate made by Tosoh F-Tech Inc. by the synthesis process described in Polymer Journal, Vol. 10, 1994, pp. 1118-1123, and 1.0 gram of A-TMM-3L (pentaerythritol triacrylate) made by Shin-Nakamura Chemical Co., Ltd. were mixed with 200 mg of IRGACURE 184 made by Novartis AG, 1 mg of R202 made by Evonik Ltd. (fumed silica treated with dimethyl silicon oil) and 200 mg of methyl isobutyl ketone, and the mixture was stirred until it was visually found to become uniform.

A part (60 mg) of the obtained solution was passed by a pipette over a glass sheet that was in turn fixed by adsorption onto the stage of a spin coater, and the spin coater was stopped after the revolutions per minute was increased from 0 rpm up to 1,000 rpm over 10 seconds. Then, the composition on that glass sheet was irradiated with light from a high-pressure mercury lamp made by Harison Toshiba Lighting Co., Ltd. for about 1 second (320 nm to 390 nm, 500 mJ/cm²), whereupon a tackiness-free transparent coating layer was obtained.

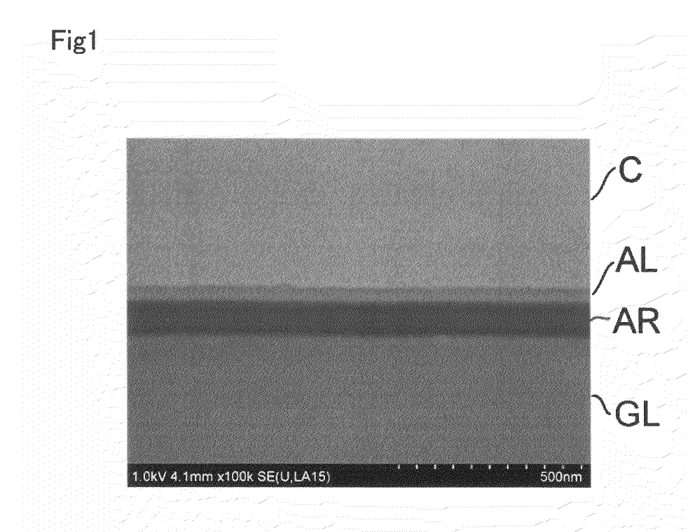

As a protective film for keeping the obtained coating layer (AR) against damage caused upon cutting, two films: an aluminum deposited film (AL) and a carbon deposited film (C) were formed on that coating layer. The glass sheet having the coating layer was laser cut, and the section was observed under a SEM to obtain a section image. The obtained section image is attached hereto as FIG. 1. As can be seen from FIG. 1, it has been found that the uniform protective layer (AR) of 90 nm in thickness is formed on a glass sheet (GL) in close contact with it.

### INDUSTRIAL APPLICABILITY

The coating layer for solar batteries according to the invention may be used for making improvements in the ability of solar batteries to collect light. The inventive coating layer may readily be formed by a simple process into a protective layer of a solar battery. The inventive coating layer could preferably be applied to various types of solar batteries regardless of the types of power generation substrates based on silicon such as ones of single crystal, polycrystal and amorphous silicon semiconductor types, compounds such as CIGS, and organic materials such as ones of hue sensitization types and organic thin-film models.

1. A coating layer form solar batteries, comprising a resin containing at least fluorine and an acrylic or methacrylic acid derivative, wherein:
said fluorine is contained in an amount of 5% by mass or greater, said coating layer being formed on a protective layer of a solar battery module in direct contact with the air.

2. The coating layer for solar batteries according to claim 1, wherein said fluorine is contained in an amount of 20 to 80% by mass.

3. The coating layer for solar batteries according to claim 1, which has a film thickness of 30 nm to 300 nm, and a refractive index of 1.30 to 1.50 with respect to light of 400 nm wavelength.

4. The coating layer for solar batteries according to claim 1, which has an angle of contact of 65 degrees to 120 degrees with water.

5. The coating layer for solar batteries according to claim 1, which is obtained by forming into a film a composition comprising either one of the following components (a) and (b), the following component (c) and an organic solvent:
Component (a): one or two or more of methacrylate compounds and acrylate compounds containing a fluoroalkyl group having 1 to 10 carbon atoms,
Component (b): a fluorine-containing polymer, and
Component (c): one or two or more of acrylic acid derivatives and methacrylic acid derivatives containing 1 to 5 acryloyl groups or methacryloyl groups.

6. A process for producing a coating layer for solar batteries, wherein a composition comprising at least either one of the following components (a) and (b), the following component (c) and an organic solvent is formed into a film that is in turn polymerized and cured to obtain a coating layer for solar batteries:
Component (a): one or two or more of methacrylate compounds and acrylate compounds containing a fluoroalkyl group having 1 to 10 carbon atoms,
Component (b): a fluorine-containing polymer, and
Component (c): one or two or more of acrylic acid derivative and methacrylic acid derivatives containing 1 to 5 acryloyl groups or methacryloyl groups.

7. The production process according to claim 6, wherein said component (b) is contained in an amount of 0.1 to 50 parts by weight, and said component (c) is contained in an amount of 1 to 50 parts by weight.

8. The production process according to claim 6, wherein both said components (a) and (b) are contained, said component (a) being contained in an amount of 1 to 90 parts by weight and said component (b) being contained in an amount of 0.1 to 50 parts by weight, and said component (c) is contained in an amount of 1 to 50 parts by weight.

9. The production process according to claims 6, wherein fumed silica is contained as a component (d).

10. The production process according to claim 9, wherein said component (a) is contained in an amount of 1 to 90 parts by weight, and said component (c) is contained in an amount of 1 to 50 parts by weight.

11. The production process according to claim 6, wherein a polymerization initiator is further contained.

12. The production process according to claim 6, wherein the fluorine-containing polymer that is said component (b) is a copolymer comprising 10 to 50 parts by mole of one or two or more of fluorine-containing polymers having cyclic structures represented by the following formulae (1), (2) and (3) and tetra-fluoroethylene, 0 to 50 parts by mole of hexafluoro-propylene, 90 to 10 parts by mole of vinylidene fluoride, and 10 to 100 parts by mole of vinyl fluoride: [chemical structure]
